(19) United States
(12) Patent Application Publication
(10) Pub. No.: US 2005/0283381 A1
(43) Pub. Date: Dec. 22, 2005

(54) System and method to manipulate identification data of medical images and data sets for quality assurance

(76) Inventors: Volker Schmidt, Erlangen (DE); Hans Schull, Weisendorf (DE); Werner Striebel, Schwarzenbruck (DE); Dieter Arnold, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/873,003

(22) Filed: Jun. 22, 2004

(51) Int. Cl. G06Q 10/00

(52) U.S. Cl. 705/2

(57) ABSTRACT

Identification information is overwritten onto a defined region of a medical image or examination data. Original data formerly occupying the overwritten region is saved and stored on a server, and associative information identifying the storage location of the original data is determined and optionally written into the defined region. The original medical image can be reconstructed by locating the stored original data from the associative information and placing the original data back into the defined region.

### BACKGROUND OF THE INVENTION

The present invention is directed to a system and appertaining method for manipulating identification data of medical images and data sets for quality assurance.

Digital medical data sets (for example, x-ray images, ultrasound images, fundus images, EKG, etc.) are provided with identifying data of a patient and examination data (designated as “ident data” in the following) in order to prevent confusions of the data sets.

A method is needed with which the ident data can be manipulated, while at the same time the legal security requirements with regard to the identification requirements are fulfilled. Such a manipulation can be necessary for quality assurance purposes, or for the anonymization or pseudonymization of images when, for example, data previously found by an examiner must be provided to him a second time without him being able to identify the case via its identifying data. At the same time, it must be ensured that the data sets do not differ from those used in routine operation.

The following explanation describes known procedures to identify medical data sets, and references FIGS. 1A and 1B. According to a known process, desired ident data 20 is written into a medical image 18 in an area of the image (data set) in which no relevant medical information is present 12. Two different methods are currently used to accomplish this:

a) (FIG. 1A) the ident data 20 are written into the original image—the original data 16 is thereby lost and replaced by this writing. The advantage to this approach is that the ident data 20 become a part of the image and can no longer be manipulated in an easy manner or be lost in transmission.

b) (FIG. 1B) the ident data 20 are maintained separately, but are placed over the unaltered image 18 (overlay technique) upon the display of the data set. The advantage to this approach is that the original data 16 remain unaltered, and the image 18 can optionally be output with or without identifying data 20. The disadvantage of this method is that the identifying 20 information can be lost.

U.S. Pat. No. 6,301,360 discloses a method of encoding information according to a position-based encoding scheme. In this method, data sequences are encoded into another data entity, such as a pixel-based image or medical record. The position for values to be changed are determined by a reversible function.

### SUMMARY OF THE INVENTION

It is the object of the present invention to provide a system and appertaining method for providing ident data to a medical record that does not destroy a part of the original data while at the same time reduces or eliminates the possibility that the ident information becomes lost or disassociated with the examination/medical data.

This object is achieved by a method for providing ident data with medical image or examination data, comprising: collecting ident data regarding a subject; collecting an original medical image or examination data (original image data) regarding the subject; defining a region in the image data into which the ident data will be written; copying the image data from the defined region as original data in a storage location remote from the image data; generating associative information identifying the storage location of the original data; and writing the ident data into the defined region of the original image data, thereby producing overwritten image data.

This object is also achieved by a system for providing ident data with medical image or examination data (image data), comprising: an imaging or recording device configured to collect image data from a subject; a local processor connected to the imaging or recording device and having an input for receiving the image data; a network connected to the local processor; a server that is also connected to the network, the server having a storage device connected to it that has a memory for storing original data taken from a defined region of the image data obtained from the local processor; an ident data generator configured to generate ident data related to the subject and put the ident data into the defined region of the image data from which the original data was taken; and an associative data generator configured to generate data associating the original data with a memory location of the server storage device.

### DESCRIPTION OF THE DRAWINGS

Embodiments of the invention are described below with reference to the following drawing figures.

FIG. 1A is a block diagram of a known medical data set identification scheme in which examination data is overwritten with ident data;

FIG. 1B is a block diagram of a known medical data set identification scheme in which identification data is provided as an overlay;

FIG. 2 is a pictorial diagram illustrating the major components of the inventive medical data set identification system; and

FIG. 3 is a block diagram illustrating an embodiment of the inventive medical data set identification system.

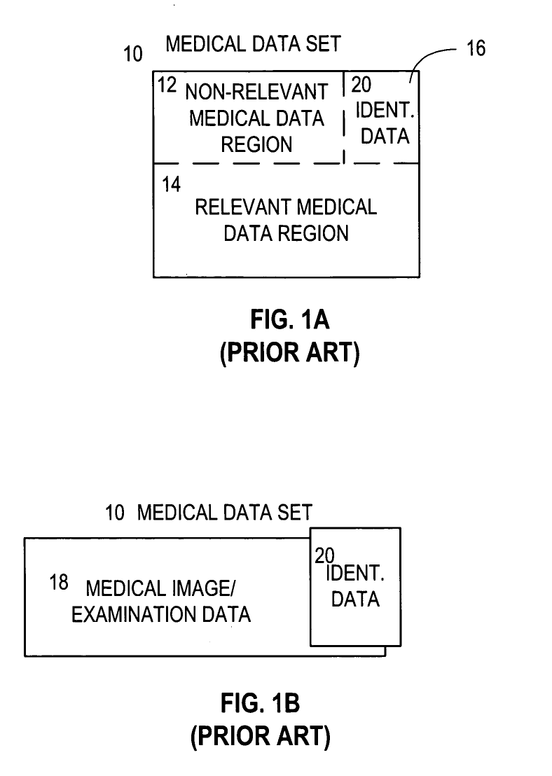

### DETAILED DESCRIPTION OF THE PREFERRED EMBODIMENTS

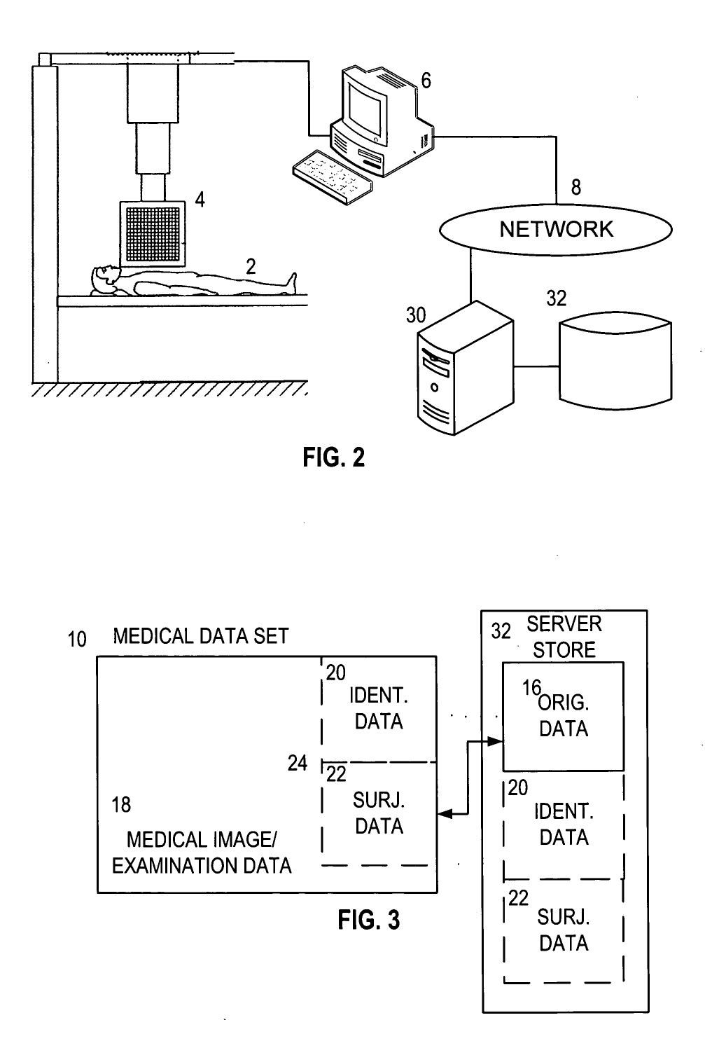

Various embodiments of the invention are described below. FIG. 2 illustrates the major components of the system. A subject 2 undergoes a medical procedure using an imaging or recording device 4, such as an x-ray, ultrasound, EKG, etc. A medical image (or examination data, collectively hereinafter “medical image”) 18 is retrieved from the recording device 4 and stored on a local processor 6 (either directly or indirectly by, e.g., scanning from a non-digital medium such as paper or film). Ident information 20 is collected regarding the user that may include name, age, gender, medical condition, test procedure, or any other relevant information related to the subject or the procedure being performed. This information may be collected by the local processor 6 or other system.

The local processor is connected through a network 8, which may be a local area network or a wide area network, such as the Internet, to a server 30 that has storage device 32 associated with it.

According to the inventive method, and as illustrated in FIG. 3, ident data 20 for a subject 2 is gathered by any type of medical procedure in a manual and/or automated process either before, concurrently with, or after medical image or examination data 18 is gathered for the subject 2.

A region 24 of the medical image 18 is defined in which the ident data 20 and any additional associative (surjective) data 22 will be placed. This region 24 may be defined by coordinate boundaries, or it may be fixed, depending on a type or class of medical image 18, or it may even be defined by a bitmap. What is important is that this region be large enough to hold any ident data 20 and associative or surjective data 22 that will later be applied to the medical image.

The original data 16 from this defined region 24 is copied or moved from the medical image 18 and stored electronically in a location remote (i.e., remote from a contact proximity) from the medical image data 18, such as on the storage device 32 of the server 30. The original data 16 that has been saved can be made available via, e.g., the server 30 via the network 8. When a new image 18 is generated, the original data 16 of the area in which the ident data 20 are written are sent to the server 30. The server 30 stores the original data 16, generates a associative information (e.g., surjective identification) 22 identifying the location of the stored original data 16, and delivers the associative information 22 back to a device, e.g., the local processor 6, in the image-generating location. The local processor 6 may be used to write the ident data 20 together with the associative information 22 into the original image 18. The original data 16 are thus stored in a remote location such that the original image can be produced again as needed.

The storage of the original data 16 can ensue in image formats that support the storage of supplementary information, such as DICOM, via utilization of the image format. DICOM is a standard for Digital Imaging and Communications in Medicine developed by the American College of Radiology (ACR) and the National Electrical Manufacturers Association (NEMA). This Standard is developed in liaison with other Standardization Organizations including CEN TC251 in Europe and JIRA in Japan, with review also by other organizations including IEEE, HL7 and ANSI in the USA. In the event that a particular image format does not support the storage of the original data 16, this data can be stored in an additional or alternative databank according to some form of identification of the image. The medical image data 18 can originate from all medical modalities (e.g., x-ray (Rö), magnetic resonance (MR), computed tomography (CT), ultrasound (US), fundus exposures, electrocardiogram (EKG), etc) and medical data collection devices.

After the ident data 20 is collected, this data 20 is written to the defined region 24 of the medical image data 18, along with the additional data 22 that may be used to identify the location of storage of the original data 16. This additional/surjective identification 22 can be part of the ident data 20 inserted into the original medical image data 18 in the defined region 24. The original data 16 can then be retrieved or recovered using the surjective identification data 22 of the original data 16. This surjective identification data 22 can thus be part of the meta-information of an image 18.

In order to restore the overwritten medical image 18 to its original form, the ident data 20 region and the surjective data region 22 must be exchanged with the original data 16. The original data 16 is first retrieved using the surjective identification 22 of the original data 16 and used again in the image 18. New ident information 22 can then be generated and inserted into the image 18.

The same original image 18 can be manipulated multiple times; the surjective identification 22 can be written over in a consistent area in which the ident data 20 are written; the association with an original image remains. In this case, it is reasonable to also store the true ident data 20 separately, in addition to the original image data 16.

The algorithm which sends the original data 16 to the server 30 can supply not only one image region (for example, a rectangular region) for storage, but rather it can send precisely the amount and location of the pixels manipulated by the ident data 20. Exactly one original data set 16 belongs to a surjective identification 22 (surjective with regard to the true ident data); in other words, there is a one-to-one correspondence between the original data set 16 and its identification 22.

Although not an ideal alternative, the surjective identification data 22 may be associated solely with the original data 16 on the storage area 32 of the server 30 and not with the overwritten medical image data 18. This approach, while workable, has the danger that if the mapping on the server 30 is ever destroyed, it would be impossible (for any significant number of medical image data sets 18) to match the original data 16 with the associated medical image data 18.

Alternately, the ident data 20 and/or the associative/surjective identification data 22 may be stored redundantly on the server storage area 32 along with the original data 16.

Furthermore, although there should be a one-to-one correspondence of original data sets 16 with the corresponding surjective identification 22, there is no reason that a single medical image data set 18 cannot utilize more than one ident data set 20. Advantageously, such an inventive embodiment may be used in a quality control context. For quality control purposes, a particular image may be provided to multiple viewers or finders (an interperson test); these viewers are often working together in a common room or institution. If a plurality of viewers get a simultaneously distributed medical data set 10 having the same ident data 20 on it, they might then be able to identify the image as a quality control image by comparison, and thus might respond differently to it. Inventive embodiments permit providing multiple copies of a particular original image with different ident data 20 so that the viewers cannot make such an association.

Similarly, for quality control testing of intragrader/intraperson reliability (i.e., repeatability/reproducibility within a particular viewer), using different ident data 20 when giving the same file to a viewer multiple times in a temporally spaced manner will reduce the likelihood that the viewer would recognize the image as a quality control image based on a repeated viewing of the same ident data 20.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### REFERENCE CHARACTERS

2 subject
4 imaging or recording device
6 local processor
8 network
10 medical data set
12 non-relevant medical data region
14 relevant medical data region
16 original data
18 medical image/examination data
20 surjective identification data
22 associative/surjective data
24 region into which ident and surjective data is added
30 server
32 server storage device

1. A method for providing ident data with medical image or examination data, comprising:
collecting ident data regarding a subject;
collecting an original medical image or examination data (original image data) regarding the subject;
defining a region in the image data into which the ident data will be written;
copying the image data from the defined region as original data in a storage location remote from the image data;
generating associative information identifying the storage location of the original data; and
writing the ident data into the defined region of the original image data, thereby producing overwritten image data.

2. The method according to claim 1, further comprising:
transmitting the associative information to a site at which the image data is being collected or updated; and
writing the associative information into the defined region of the image data.

3. The method according to claim 1, further comprising:
determining coordinate or bitmap information related to the defined region; and
storing the determined coordinate or bitmap information along with the associative information.

4. The method according to claim 1, further comprising:
retrieving the original data stored in the storage location utilizing the associative information; and
writing the original data to the defined region of the image data, thereby reconstructing the original image data.

5. The method according to claim 1, wherein the associative information is surjective data.

6. The method according to claim 1, wherein the original data is copied and stored in DICOM format.

7. The method according to claim 1, wherein the copying of the image data further comprises transmitting the image data over a network to the storage location.

8. The method according to claim 7, wherein the storage location is an electronic storage device connected to a server on the network.

9. The method according to claim 1, further comprising storing the associative information along with the original data in the storage location.

10. The method according to claim 1, wherein the medical image or examination data is selected from the group consisting of an x-ray, magnetic resonance imaging, CAT scan, ultra-sound, fundus exposures, and electrocardiogram.

11. The method according to claim 1, wherein collecting the ident data is performed by a local processor.

12. The method according to claim 1, wherein the defined region is a rectangular region.

13. The method according to claim 1, further comprising creating a plurality of ident data sets for a single image data.

14. The method according to claim 13, further comprising utilizing the plurality of ident data sets in a quality control function.

15. The method according to claim 14, wherein the quality control function comprises performing an inter-person quality control test.

16. The method according to claim 14, wherein the quality control function comprises performing an intra-person quality control test.

17. A system for providing ident data with medical image or examination data (image data), comprising:
an imaging or recording device configured to collect image data from a subject;
a local processor connected to the imaging or recording device and having an input for receiving the image data;
a network connected to the local processor;
a server that is also connected to the network, the server having a storage device connected to it that has a memory for storing original data taken from a defined region of the image data obtained from the local processor;
an indent data generator configured to generate ident data related to the subject and put the indent data into the defined region of the image data from which the original data was taken; and
an associative data generator configured to generate data associating the original data with a memory location of the server storage device.
